(19) United States
(12) Patent Application Publication
(10) Pub. No.: US 2023/0072470 A1
(43) Pub. Date: Mar. 9, 2023

(54) SYSTEMS AND METHODS FOR SELF-ADMINISTERED SAMPLE COLLECTION

(71) Applicant: EMED LABS, LLC, Miami, FL (US)

(72) Inventors: Sam Miller, Hollywood, FL (US); Colman Thomas Bryant, Fort Lauderdale, FL (US); Zachary Carl Nienstedt, Wilton Manors, FL (US); Maria Teresa Pugliese, Miami, FL (US)

(21) Appl. No.: 17/929,120

(22) Filed: Sep. 1, 2022

Related U.S. Application Data
(60) Provisional application No. 63/260,911, filed on Sep. 3, 2021.
(60) Provisional application No. 63/263,801, filed on Nov. 9, 2021.
(60) Provisional application No. 63/261,873, filed on Sep. 30, 2021.
(60) Provisional application No. 63/363,418, filed on Apr. 22, 2022.

(51) Int. Cl. H04N 5/232

(52) U.S. Cl. CPC H04N 5/23222; H04N 5/23219

(57) ABSTRACT

The present disclosure is directed to systems, methods, and devices for self-administered sample collection. These systems, methods, and devices may make it easier for patients to obtain orders for medical testing from a medical provider and for patients to carry out sample collection procedures themselves in an acceptable manner. For example, the disclosure may enable easier self-imaging of a patient's mouth and/or throat, or may induce saliva production such that it is easier for a patient to generate a sufficient amount of sample for a saliva-based test.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority benefit of U.S. Provisional Application No. 63/260,911, filed Sep. 3, 2021, U.S. Provisional Application No. 63/263,801, filed Nov. 9, 2021, U.S. Provisional Application No. 63/261,873, filed Sep. 30, 2021, and U.S. Provisional Application No. 63/363,418, filed Apr. 22, 2022 which are hereby incorporated by reference in their entirety herein.

### BACKGROUND

### Field

The present disclosure is directed to remote medical diagnostic testing. Some embodiments are directed to self-administered sample collection.

### Description

The approaches described in this section are approaches that could be pursued, but not necessarily approaches that have been previously conceived or pursued. Thus, unless otherwise indicated, it should not be assumed that any of the material described in this section qualifies as prior art merely by virtue of its inclusion in this section.

Use of telehealth to deliver healthcare services has grown consistently over the last several decades and has experienced very rapid growth in the last several years. Telehealth can include the distribution of health-related services and information via electronic information and telecommunication technologies. Telehealth can allow for long-distance patient and health provider contact, care, advice, reminders, education, intervention, monitoring, and remote admissions. Often, telehealth can involve the use of a user or patient's personal computing device, such as a smartphone, tablet, laptop, personal computer, or other type of personal computing device.

Remote or at-home healthcare testing and diagnostics can solve or alleviate some problems associated with in-person testing. For example, health insurance may not be required, travel to a testing site is avoided, and tests can be completed at a patient's convenience. However, remote or at-home testing introduces various additional logistical and technical issues, such as guaranteeing timely test delivery to a patient, providing test delivery from a patient to an appropriate lab, ensuring proper sample collection, ensuring test verification and integrity, providing test result reporting to appropriate authorities and medical providers, and connecting patients with medical providers and proctors, who are sometimes needed to provide guidance and/or oversight of remote testing procedures. For example, in some circumstances, a patient may need an order from a doctor in order to take a test.

In some cases, patients may encounter difficulty following testing procedures needed to ensure that samples are suitable for laboratory testing. For example, users may be unfamiliar with sample collection processes. While users may collect samples in some ways (e.g., using a nasal swab) with relative ease, other types of sample collection may be more difficult. For example, a user may struggle to collect a sample from their throat for a variety of reasons, such as being unable to see their throat clearly, accidentally touching the collection device to their tongue, and so forth.

Various other types of tests require saliva collection, such as at-home collection for DNA sequencing, various in vitro diagnostic rapid molecular tests, drug tests, etc. These tests may require that the testing user produce a significant amount of saliva. For example, during such tests, users may need to generate and spit a certain volume of saliva into a test tube or other container, or may need to collect saliva using a swab. In some instances, the testing user may produce insufficient saliva, resulting in frustration to the testing user and possibly to the collected sample being insufficient or otherwise unsuitable for testing.

Additionally, a remotely located user (e.g., an at-home patient) may need to perform certain tasks on their own (e.g., without the assistance of an in-person healthcare professional). For example, during a telehealth consultation or test that involves inspecting the remotely located user's mouth or throat, the user may be instructed to capture one or more pictures and/or videos of the user's mouth or throat using a user device, such as a smartphone, tablet, laptop, personal computer, or other type of personal device. These pictures can then be sent over a network to a healthcare platform where they can be reviewed and analyzed by a healthcare professional.

However, capturing a picture or video of one's own mouth or throat, can be difficult as, in order to align the camera on the user device with one's mouth, it may not be possible to simultaneously view the output of the camera on a display of the user device. Thus, it can be difficult for the user to properly align the camera on the user device with his or her mouth, ensure that the features of interest are captured within the frame, and/or ensure that the image or video is in focus and/or adequately lit, among other issues.

### SUMMARY

Among other things, this application describes systems, methods, and devices for self-administered sample collection. These systems, methods, and devices may make it easier for patients to obtain orders for medical testing from a medical provider and for patients to carry out sample collection procedures themselves in an acceptable manner. This can lead to improved outcomes as patients are less likely to collect samples that cannot be used for testing or that produce inaccurate results. In some instances, the present disclosure provides for systems and methods that can aid users in collecting throat samples.

Additionally, some of the systems, methods, and devices described in this application facilitate and enable users to self-image their own mouth and/or throat and may help to alleviate the challenges associated with such self-imaging. In some embodiments, the systems, methods, and devices described herein may implement face tracking techniques to facilitate self-imaging of the mouth or throat. For example, keypoints corresponding to a user's upper and lower lips can be identified and tracked within images that are captured by the camera of the user device. Using these keypoints, a distance between the upper and lower lip can be determined to provide a measure of how wide the user's mouth is open and/or a distance between the camera of the user device and the user's mouth. In some instances, in order to adequately image the inside of the user's mouth and/or the user's throat, the user's mouth must be opened wide enough to reveal their mouth or throat to the camera of the smartphone, and the camera of the smartphone must be positioned sufficiently close to the opening of the user's mouth and oriented in a manner such that the inside of the user's mouth and/or the user's throat is sufficiently within the field of view (FOV) of the camera. Based on the distances and calculations determined from the keypoints, the systems, methods, and devices described herein can ensure that these conditions are met before images are captured.

In telehealth and other contexts, imaging of the mouth and throat may be leveraged for the remote evaluation and diagnosis of strep throat, mouth and gum disease, postnasal drip, and the like, as well as for the remote provision of dental and/or orthodontic services, among other uses.

In one aspect, a computer-implemented method for assisting a user in self-imaging a user's mouth or throat using a camera on a user device can include: receiving, by a computer system, a first set of images captured by the user using the camera of the user device, the first set of images include a view of a mouth of the user; determining, by the computer system and based on the first set of images, an extent to which the mouth of the user is open; determining, by the computer system and based on the first set of images, a distance between the camera and the mouth of the user; based on the extent to which the user's mouth is open and the distance between the camera and the user's mouth, determining, by the computer system, that one or more image criteria is met, the image criteria configured to ensure that the mouth and throat of the user are visible within a field of view of the camera; and based on determining that the image criteria are met, causing, by the computer system, the user device to capture a second set of images of the user's mouth using the camera on the user device.

The method may include one or more of the following features in any combination: (a) wherein determining, based on the first set of images, an extent to which the user's mouth is open comprises identifying, by the computer system, keypoints within the first set of images associated with an upper lip and a lower lip of the user, and determining, by the computer system, a distance between the keypoints; (b) based on determining that the image criteria are not met, providing, by the computer system, instructions to the user to reposition the camera; and receiving, by the computer system, an updated first set of images from the camera of the user device; (c) wherein the instructions comprise audio instructions played on a speaker of the user device; (d) sending, by the computer system, the second set of images over a network to a telehealth platform for analysis or review; (e) wherein the image criteria include a degree to which the mouth of the user is open exceeding a threshold degree; (f) wherein the image criteria include a distance between the mouth of the user being within a threshold distance; (g) wherein the image criteria include a determination that a feature of interest is positioned within a center region of the field of view of the camera; (h) wherein the feature of interest comprises the throat of the user; (i) causing, by the computer system, a flash of the user device to trigger prior to capturing the second set of images; (j) wherein one or both of the first set of images or the second set of images comprises a single image; and/or other features as described herein.

In another aspect, a computer system for assisting a user in self-imaging a user's mouth or throat using a camera on a user device can include at least one memory and at least one processor, the at least one memory storing instructions that cause the processor to: receive a first set of images captured by the user using the camera of the user device, the first set of images include a view of a mouth of the user; determine, based on the first set of images, an extent to which the mouth of the user is open; determine, based on the first set of images, a distance between the camera and the mouth of the user; based on the extent to which the user's mouth is open and the distance between the camera and the user's mouth, determine that one or more image criteria is met, the image criteria configured to ensure that the mouth and throat of the user are visible within a field of view of the camera; and based on determining that the image criteria are met, cause the user device to capture a second set of images of the user's mouth using the camera on the user device.

The system can include one or more of the following features in any combination: (a) wherein determining, based on the first set of images, an extent to which the user's mouth is open comprises identifying keypoints within the first set of images associated with an upper lip and a lower lip of the user, and determining a distance between the keypoints; (b) wherein the processor is further configured to, based on determining that the image criteria are not met, provide instructions to the user to reposition the camera; and receive an updated first set of images from the camera of the user device; (c) wherein the instructions comprise audio instructions played on a speaker of the user device; (d) sending the second set of images over a network to a telehealth platform for analysis or review; (e) wherein the image criteria include a degree to which the mouth of the user is open exceeding a threshold degree; (f) wherein the image criteria include a distance between the mouth of the user being within a threshold distance; (g) wherein the image criteria include a determination that a feature of interest is positioned within a center region of the field of view of the camera; (h) wherein the feature of interest comprises the throat of the user; (i) causing a flash of the user device to trigger prior to capturing the second set of images; (j) wherein one or both of the first set of images or the second set of images comprises a single image; and/or other features as described herein.

In another aspect, a securement device for assisting a user in self-imaging a user's mouth or throat using a camera on a user device can include: a first support configured to contact a proximal-facing side of the user device; a second support configured to contact a distal-facing side of the user device, wherein the second support is parallel to the first support; a base portion comprising: a proximal-facing side coupled to a bottom edge of the first support; a distal-facing side coupled to a bottom edge of the second support; and an attachment mechanism; a tongue depressor coupled to the base portion by the attachment mechanism; and a mirror movably attached to the base portion, wherein the mirror is configured to direct light from a flashlight of the user device into the user's mouth or throat. The attachment mechanism can be configured to receive and secure a tongue depressor. The user device can be a mobile phone or a tablet. The mirror can extend from the base portion in an opposite direction than the first support and the second support.

In another aspect, a securement device for assisting a user in self-imaging a user's mouth or throat using a camera on a user device can include: a first support configured to contact a proximal-facing side of the user device; a second support configured to contact a distal-facing side of the user device, wherein the second support is parallel to the first support; and a connector portion comprising: a proximal-facing side coupled to a bottom edge of the first support; a distal-facing side coupled to a bottom edge of the second support; and an attachment mechanism. The attachment mechanism can be configured to receive and secure a tongue depressor. The attachment mechanism can be a clip. The securement device can include a mirror.

Additionally, this application describes systems, methods, and devices for increasing saliva production in testing users in order to increase success rates with at-home testing requiring saliva samples, making the collection process faster and creating an overall better testing user experience and result.

For purposes of this summary, certain aspects, advantages, and novel features are described herein. It is to be understood that not necessarily all such advantages may be achieved in accordance with any particular embodiment. Thus, for example, those skilled in the art will recognize the disclosures herein may be embodied or carried out in a manner that achieves one or more advantages taught herein without necessarily achieving other advantages as may be taught or suggested herein.

All of the embodiments described herein are intended to be within the scope of the present disclosure. These and other embodiments will be readily apparent to those skilled in the art from the following detailed description, having reference to the attached figures. The invention is not intended to be limited to any particular disclosed embodiment or embodiments.

### BRIEF DESCRIPTION OF THE DRAWINGS

These and other features, aspects, and advantages of the present disclosure are described with reference to drawings of certain embodiments, which are intended to illustrate, but not to limit, the present disclosure. It is to be understood that the attached drawings are for the purpose of illustrating concepts disclosed in the present disclosure and may not be to scale.

FIG. 1 is a flowchart illustrating a testing process according to some embodiments.

FIGS. 2A-2D illustrate various steps in an example testing process according to some embodiments.

FIG. 3 is a flow chart illustrating an example embodiment of a method for self-imaging of the mouth and/or throat.

FIG. 4 is a flow chart illustrating another example embodiment of a method for self-imaging of the mouth and/or throat.

FIG. 5 illustrates a feature relating to the collection of a throat sample.

FIG. 6 shows an example of a self-collection process in which a tongue depressor attachment is attached to the user's phone.

FIG. 7 shows another example of a self-collection process in which a tongue depressor attachment is attached to the user's phone.

FIG. 8 illustrates an example of how a system may instruct a user to collect a mouth and/or throat sample.

FIG. 9 depicts an example of a testing user observing a picture of a food item prior to collecting saliva as part of an at-home testing procedure.

FIG. 10 depicts an example of a testing user responding to a stimulus by increasing saliva production.

FIG. 11 depicts an example of a testing user self-collecting a saliva sample using a collection swab.

FIG. 12 illustrates an embodiment of a computer system that can be configured to perform one or more of the processes or methods described herein.

### DETAILED DESCRIPTION

Although several embodiments, examples, and illustrations are disclosed below, it will be understood by those of ordinary skill in the art that the disclosures described herein extend beyond the specifically disclosed embodiments, examples, and illustrations and includes other uses of the inventions and obvious modifications and equivalents thereof. Embodiments are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

This disclosure describes systems, methods, and devices for the self-collection of samples for medical or diagnostic testing. For some types of medical or diagnostic tests such as, for example, a test for COVID-19, the test may be administered and results may be obtained at home. Some medical or diagnostic tests, however, may be sent to a laboratory or other facility to determine results. In some embodiments, medical tests may be available over the counter (i.e., without a prescription or doctor's order), while other tests may require a doctor's order. At times, even if a sample needs to be sent to a laboratory or other facility, it may be preferable or advantageous for the patient to collect the sample at home such as, for example, if the patient is located far from a testing facility, if the patient is too ill to travel, or if the patient simply prefers the convenience of testing at home.

In some embodiments, a patient may obtain a doctor's order for a test using telehealth. For example, in some embodiments, a testing platform may receive a first set of data comprising a first request from a patient for medical care. The patient may provide to the testing platform a set of data that may include, for example, information to identify the user such as, for example, a driver's license, a passport, or some other identity document. In some embodiments, the patient may include one or more images of a portion of the patient's body as part of the request. For example, a patient may provide images of a mole, rash, wound, burn, or the like.

In some embodiments, a medical provider may review the patient's request and the one or more included images. The medical provider may then determine whether or not to order a medical diagnostic test. If the medical provider orders a diagnostic test, a system may then perform one or more actions such as placing an order for a sample collection kit to be sent to the patient.

In some embodiments, upon receipt of the sample collection kit by the patient, the testing platform may receive a second set of data from the patient which may include, for example, identification information and one or more images. The testing platform may then determine if one or more aspects of the second set of data conform with one or more aspects of the first set of data. For example, the testing platform may check that an identification document provided by the patient is the same in the first set of data and the second set of data, and/or the testing platform may check that the portion of the patient's body shown in one or more images in the first set of data matches the portion of the patient's body shown in one or more images in the second set of data. In some embodiments, a mismatch in the identification information and/or the portion of the body part shown in the first set of data and the second set of data may indicate that the patient has made one or more errors or may be indicative of fraud (for example, a different person attempts to collect the sample). In some embodiments, validation may continue during the sample collection process. For example, the testing platform might compare video collected during the sample collection process to images submitted with the first request.

In some embodiments, if the testing platform determines that the patient and/or body part associated with the first set of data is the same as the patient and/or body part associated with the second set of data, the testing platform may provide the patient with guidance to collect one or more samples in a manner compliant with the ordered medical or diagnostic test. For example, the patient may be provided with written instructions, video demonstrations, augmented reality-based guidance, or the like.

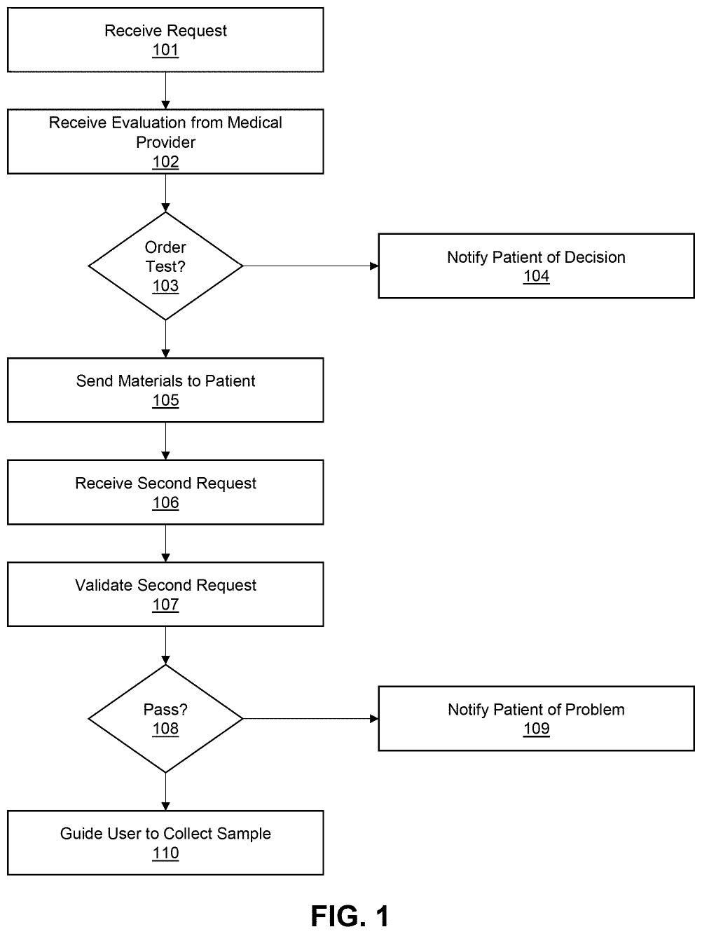

FIG. 1 is a flowchart illustrating a remote collection procedure according to some embodiments. At block 101, a testing platform receives a request from a patient. The request may include, for example, a request for medical care or a request for a diagnosis of a potential health condition. At block 102, the testing platform receives an evaluation from a medical provider. The evaluation can be made by a medical professional, such as a doctor, who has reviewed initial request received from the patient, along with any accompanying material. The evaluation may include an order for a medical test or may not include an order (e.g., a request or prescription) for a medical test. At block 103, the testing platform may determine if the medical provider ordered a test. If the provider did not order a medical test, the patient will be informed of the decision not to order a test at block 104. If the provider did order a test, test materials can be sent to the patient at block 105. For example, in some embodiments, testing materials (such as a diagnostic test kit) can be sent to the patient through the mail or delivered to the patient through the use of a courier service. In some embodiments, the user may be instructed to obtain the testing materials from a pharmacy, drugstore, or the like.

The testing platform may then receive, at block 106, a second request from the patient. The second request can include, for example, results obtained after taking a diagnostic test, a sample, collected by the user, images or vide captured by the user, or the like. At block 107, the testing platform may validate the second request by, for example, verifying an identity of the patient and/or verifying a body part of the patient. For example, the system can compare information provided in the first request (block 101) to information provided in the second request (block 106). At block 108, the system will determine if the second request has been validated. Validation can include verifying that information of the second request corresponds with information of the first request. If the validation failed, the testing platform may notify the patient at block 109 that there was a problem and that the test cannot continue. The user may be provided with additional instructions for remedying the error. If the second request passed validation, then at block 110, the testing platform may provide guidance to the patient to collect a sample.

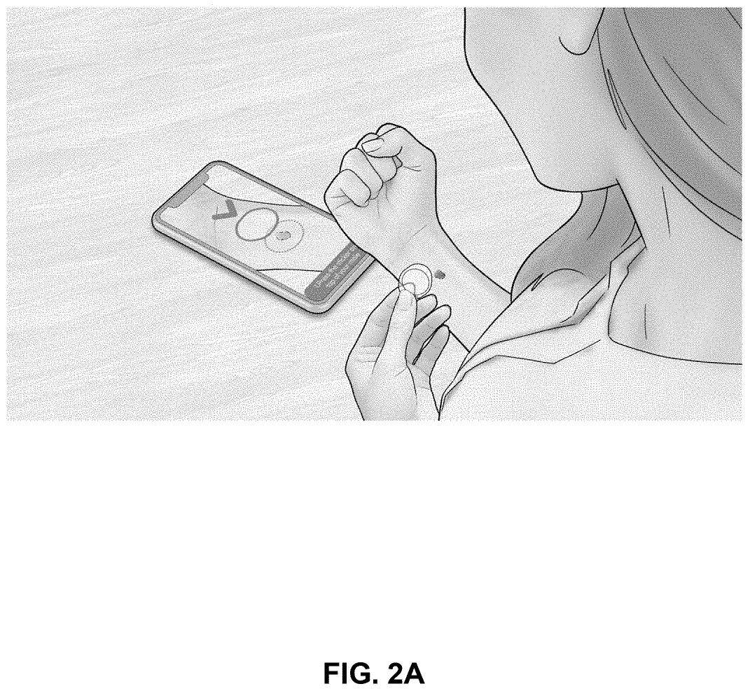

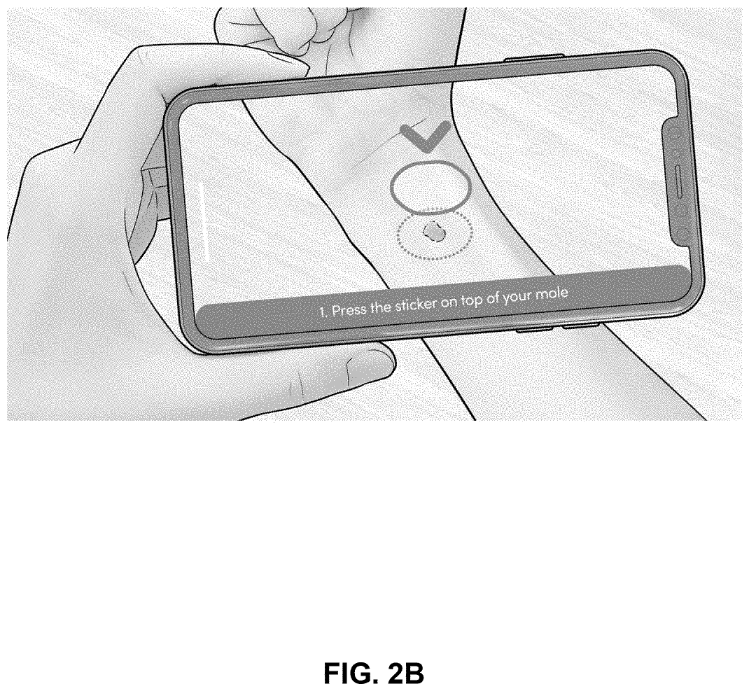

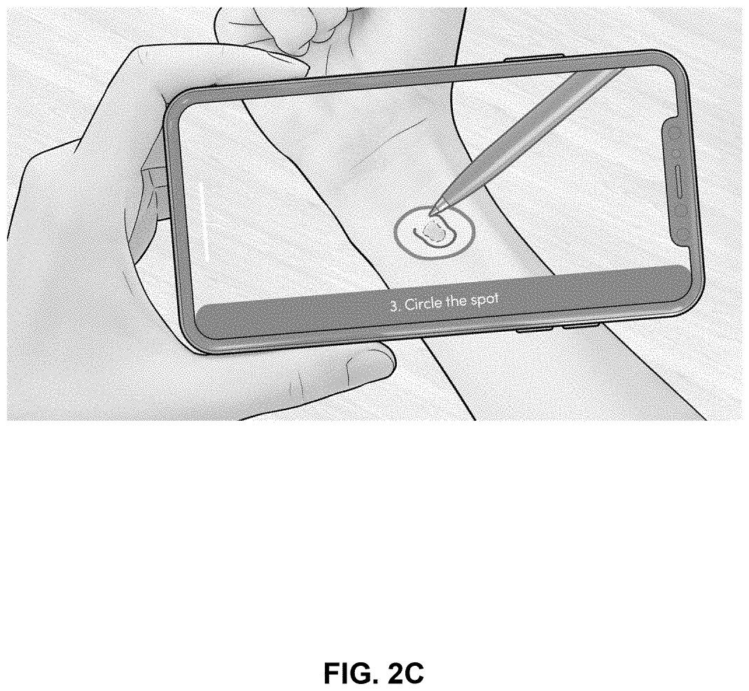

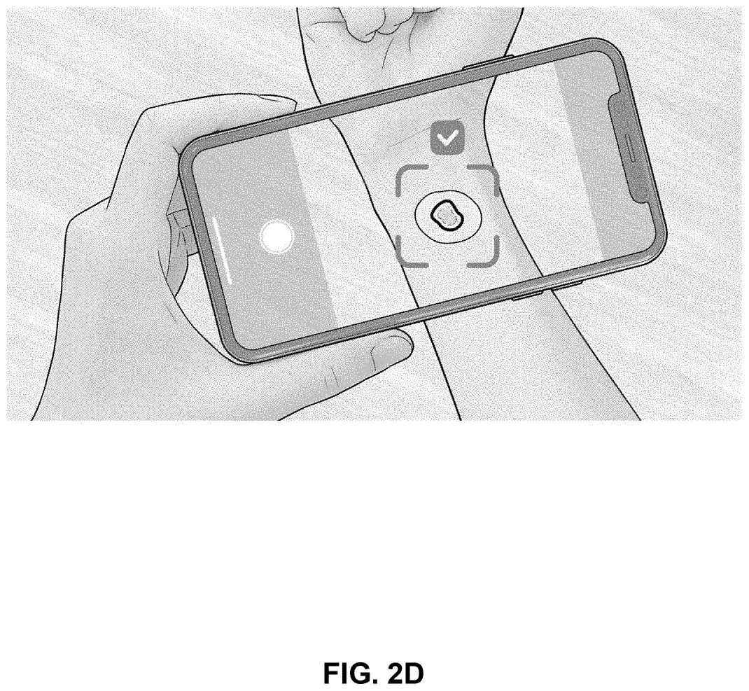

FIGS. 2A-2D illustrate an example testing process according to some embodiments. FIGS. 2A and 2B illustrate two ways in which a patient might be guided to place a sample collection sticker on the patient's body. In FIG. 2A, a patient is instructed to apply a sample collection sticker to the body. The patient is shown an image of the body part with an overlay indicating where the sample collection sticker should be placed. In FIG. 2B, the patient directs a camera of their personal computing device (for example, a smartphone camera) at the body part, and an overlay is added (e.g., augmented reality) that indicates where the patient should place the sticker. In FIG. 2C, the patient may be instructed to draw a circle on the sample collection sticker around an area of concern. Augmented reality-based guidance may be used to aid the patient in drawing the circle. In FIG. 2D, the user may be shown an indication that that sample collection sticker has been placed correctly and that the circle has been drawn correctly.

It will be understood that FIGS. 2A-2D are merely examples. In some embodiments, a patient may be provided with instructions that are text-based, video-based, picture-based, or the like. In some embodiments, a patient may interact with a proctor who may provide guidance using audio, video, text, or the like. In some embodiments, the patient may collect a skin sample, oral swab, nasal swab, or other type of sample. As just one example, a patient collecting a nasal swab may be provided instructions regarding, for example, how far to insert the swab and how long to swab the nostril.

### Examples for Mouth and Throat Sample Collection

As discussed briefly above and in more detail below, this application also provides systems, methods, and devices that are configured to enable users to more easily capture images of the inside of their mouth and/or their throat using a camera of a user device, such as a smartphone, tablet, laptop, personal computer, or other personal device.

Self-imaging (e.g., where the user uses the user device to capture an image of him- or herself) can be particularly useful in the context of telehealth. During a telehealth examination, test, or other procedure, the user can be remotely located relative to a healthcare professional or other administrator, and communication between the user and the healthcare professional can occur over a network, such as the internet. Communications between the user and the healthcare professional can occur in real-time (e.g., with a voice call, video call, or real-time chat), although this need not be the case in all embodiments. The healthcare professional can be a live person, or in some instances, an artificial intelligence (AI) system. An advantage to telehealth is that it can be available on-demand, even when access to in-person healthcare may not be available. A potential disadvantage to telehealth is that the user may be required to perform one or more tasks (such as capturing images) without the aid of an in-person healthcare professional. This disclosure provides solutions that facilitate, enable, and or improve a self-imaging experience, and thus may be particularly advantageous in the context of telehealth.

In the primary examples described herein, systems, methods, and devices for self-imaging of the user's mouth or throat. Images of the mouth or throat may be leveraged for the remote evaluation and diagnosis of strep throat, mouth and gum disease, post-nasal drip, and the like, as well as for the remote provision of dental and/or orthodontic services, among other uses.

Self-imaging of the mouth or throat can be particularly difficult as it may be difficult or impossible to position the user device such that a camera of the user device is oriented to properly capture an image of the mouth or throat, while simultaneously viewing an output of the camera on a display of the user device. For example, it may be necessary to position the camera sufficiently close to the user's mouth, such that the display of the user device is no longer visible by the user. This can leave the user essentially in the dark, requiring them to experiment through trial and error until an adequate picture is captured. This can be frustrating and lead to poor user experience. This can also lead to poor image quality, which can negatively impact the ability to adequately review and diagnose based on the image.

While the primary examples described herein relate to self-imaging of the mouth or throat, the systems, methods, and devices can be used or modified for use in other contexts as well. For example, similar techniques can be leveraged to provide for self-imaging of eyes and ears. Additionally, similar techniques can be leveraged for self-imaging in any other contexts where it may be difficult to capture an image of oneself (e.g., self-imaging of a condition on one's back). Accordingly, this disclosure should not be limited only to providing images of one's mouth or throat.

The systems, methods, and devices described herein can provide for self-imaging in an intuitive, improved, and or guided manner. In some embodiments, the techniques enable a user to use their smartphone (or other user device) to capture images of their inner mouth or throat in an intuitive manner. In some embodiments, the systems, methods, and devices leverage feature tracking techniques to facilitate self-imaging. For example, keypoints corresponding to a user's upper and lower lips can be identified within an output of a camera of the user's smartphone. The relationships between these keypoints can be determined and analyzed to determine whether the camera is positioned correctly relative to the feature(s) of interest (e.g., the throat and/or mouth). The user may continue to move the device around until the system determines that the camera is correctly positioned, at which point, one or more images of the features of interest can be captured. In some embodiments, the system may provide instructions to the user to aid in positioning the device. For example, the system may instruct the user to move the camera closer to or further from the mouth, as well as up, down, left, and right.

In some embodiments that relate to self-imaging of the mouth or throat, the keypoints may relate to the user's upper and or lower lip. In some embodiments, the system can calculate a distance, in real-time, between the upper and lower lip keypoints to determine the extent to which the user's mouth is open at any given point in time. In order to adequately image the inside of the user's mouth and/or the user's throat, the user's mouth must be open wide enough to reveal their mouth or throat to the camera of the smartphone, and the camera of the smartphone must be positioned sufficiently close to the opening of the user's mouth and oriented in a manner such that the inside of the user's mouth and/or the user's throat is sufficiently within the FOV of the camera. The system can ensure that these conditions are met before images are captured for the purposes of imaging the inside of the user's mouth and/or the user's throat.

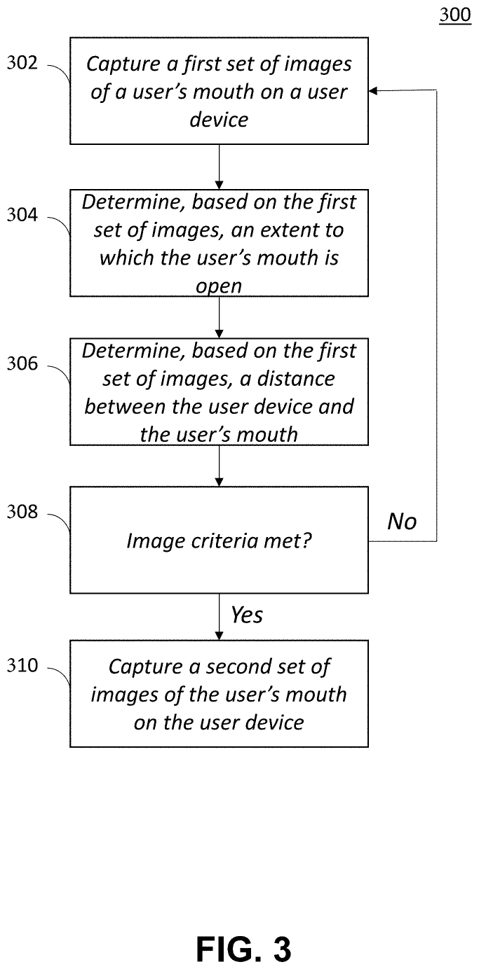

FIG. 3 is a flow chart illustrating an embodiment of a method 300 for self-imaging of the mouth and/or throat. The method 300 can be implemented as part of a telehealth system or platform. The method 300 can be implemented on a user device, such as a smartphone, tablet, laptop, personal computer, or other type of user device that includes a camera for capturing an image and/or a video.

The method 300 begins at block 302, at which the user, using a camera on a user device, captures a first set of images of the user's mouth. The first set of images can comprise a single image, a plurality of images, or a video. For example, the user may position the user device at a position that, the user believes, will capture an image of the user's mouth. As noted above, this can be difficult to do. Accordingly, the first set of images may not be of sufficient quality to allow for telehealth analysis of the images.

At block 304, the first set of images captured at block 302 can be analyzed to determine an extent to which the user's mouth is open. In some embodiments, face detection or recognition technology is used. For example, keypoints associated with the user's upper and lower lips can be identified within the first set of images. The keypoints can be analyzed to determine the degree or extent to which the user's mouth is open. The keypoints can also be analyzed to determine whether the user's mouth is centered within the FOV of the camera.

At block 306, the first set of images captured at block 302 can be analyzed to determine a distance between the user device and the user's mouth. Such analysis can be based on facial feature recognition technology and analysis of keypoints identified within the image. In some embodiments, other modalities of the user device can be used to determine the distance, such as stereographic analysis of the image, LiDAR, or others.

In some embodiments, block 306 may occur before block 304. In some embodiments, block 304 and block 306 may occur substantially simultaneously.

At block 308, the method determines whether image criteria are met which would indicate whether or not an image can be captured which will provide a sufficient or adequate view of the features of interest (e.g., the user's mouth or throat). The criteria can include, for example, the degree to which the user's mouth is open and the position of the mouth within the FOV of the camera (e.g., as determined at block 304) and the distance between the user device and the user's mouth (e.g., as determined at block 306). Other criteria can also be considered including lighting (which can involve adjusting imaging parameters of the camera and/or use of a flash of the user device). In some embodiments, the flash is only activated once the device is correctly positioned as activating the flash before the camera is adequately positioned may blind the user.

In some embodiments, the criteria can include, for example, determining, based at least in part on the first set of one or more images, a measure of an extent to which the user's mouth is open and an estimated distance between the mobile device and the user's mouth. In some such embodiments, the criteria can further include, for example, determining whether the measure of the extent to which the user's mouth is open is greater than a first threshold value and/or determining whether the estimated distance between the mobile device and the user's mouth is less than a second threshold value. The first threshold value can be indicative of a required degree to which the mouth need be opened to capture the image. The second threshold value can be indicative of a maximum distance between the camera and the mouth in order to capture an image of sufficient quality and/or detail. In some embodiments, the threshold values can be adjusted based on the camera quality, characteristics of the user (e.g., age, health conditions, etc.), and/or the features to be analyzed within the images.

If the image criteria are satisfied at block 308, the method 300 moves to block 310. At block 310 a second set of images of the user's mouth is captured using the camera of the user device. In some embodiments, a flash on the user device is activated at block 310 to illuminate the inside of the user's mouth and thus enhance the quality of the photos captured. In general, once the image criteria are met, the second set of images is captured shortly thereafter (e.g., instantaneously, substantially instantaneously, within 0.1 second, within 0.5 second, or within 1 second). In some embodiments, the second set of images comprises one or more of the first set of images. For example, the second set of images can comprise a subset of the first set of images for which the image criteria are met.

The second set of images captured at block 310 can be used for analysis and diagnosis. For example, the second set of images can be communicated over a network to a health care professional, AI system, or telehealth for review and/or further processing. For example, the second set of one or more images of the user's mouth can be used in evaluating one or more aspects of the user's health or hygiene (e.g., the second set of one or more images can be analyzed to determine whether the user may have strep throat, aggregated or used to build a 3D mesh of the inside of the user's mouth for dental purposes, etc.).

Retuning to block 308, if the image criteria are not met, the method 300 can loop back to block 302, recapturing a first set of images. In this way, the user can continue to adjust the position of the user device's camera relative to his or her mouth until a suitable position for capturing an image is achieved, at which point the image can be captured. In some embodiments, if one or more light-emitting components (e.g., a flash, a display, etc.) are located on a same surface of the user device as the camera that is used for imaging the user's mouth and throat, then the operation of at least one of the one or more light-emitting components may be controlled based at least in part on the extent to which the user's mouth is open, the distance between the camera and the user's mouth, or both.

For example, a flash of the user device may be selectively (a) activated responsive to the camera of the user device crossing one or more boundaries defined relative to the user as the distance between the camera and the user's mouth decreases, and (b) deactivated responsive to the camera of the user device crossing such one or more boundaries as the distance between the camera and the user's mouth increases. Similarly, in response to the camera of the user device crossing one or more boundaries defined relative to the user as the distance between the camera and the user's mouth changes, the user device may selectively switch between (i) a first mode of operation in which a live video stream from the camera is presented on the display at a first level of brightness, and (ii) a second mode of operation in which other content (e.g., a white screen) is presented on the display at a second level of brightness that is greater than the first level of brightness. For instance, the user device may switch from the first mode of operation to the second mode of operation responsive to the camera of the user device crossing one or more boundaries defined relative to the user as the distance between the camera and the user's mouth decreases, and may switch from the second mode of operation to the first mode of operation responsive to the camera of the user device crossing one or more boundaries defined relative to the user as the distance between the camera and the user's mouth increases. Alternatively or additionally, one or more imaging parameters of the camera may be adjusted in a similar manner. In some of the aforementioned embodiments, selective adjustment in the operation of one or more light-emitting components of the user device and/or one or more imaging parameters of the camera may occur prior to and/or independently from the operations described herein with reference to blocks 308-310.

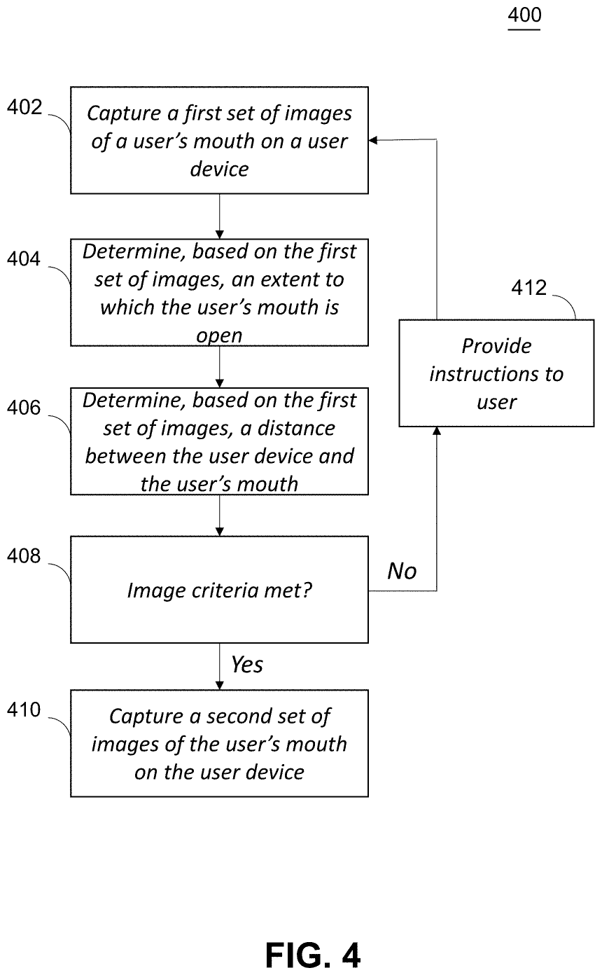

FIG. 4 is a flow chart illustrating another embodiment of a method 400 for self-imaging of the mouth and/or throat. The method 400 is similar to the method 400 but includes an additional block 412 at which instructions for positioning the camera relative to the features of interest are provided to the user. For example, when the image criteria are not met (block 408), blocks 402, 404, 406, and 408 are performed in a loop until the image criteria are met. To help the user position the camera such that the image criteria can be met, instructions can be provided to the user at block 412. For example, to assist the user in guiding the camera of their smartphone into the proper position for imaging the inside of their mouth or throat in situations where it may be difficult for the user to do so (e.g., as the user brings the smartphone closer to their mouth and the screen of the smartphone or the smartphone itself becomes difficult for the user to see), the system may, at block 412, provide audio, haptic, and/or visual feedback to the user which can include instructions for aiding the user in repositioning the user device.

In some embodiments, audio feedback can include camera lens adjustment and shutter click audio cues for helping users (who may not be able to see their screens at the time) know when camera distance and positioning is adequately framing the desired area. Audio feedback can also include voice-based instructions that tell the user to move the user device up, down, left, and/or right so as to properly position the camera relative to the user's mouth. Audio feedback can also include voice-based instructions that tell the user to move the user device closer to or further from the user's mouth. Audio feedback can also include voice-based instructions that tell the user to tilt, rotate, or otherwise reorient the user device about one or more axes so as to adjust the FOV of the camera relative to the user's mouth. The orientation of the user device may, in some embodiments, be determined based on images captured by the camera, data obtained from one or more other sensors of the user device (e.g., inertial measurement units (IMUs), gyroscopes, etc.). In some embodiments, non-voice-based audio feedback may also be employed to suggest that the user adjust the position and/or orientation of the user device in three-dimensional space relative to the user's mouth. In some embodiments, audio feedback may include an audio indication that the camera is ready to take a picture, e.g., as soon as the user device is ready (e.g., correctly positioned) to take a picture of the user's throat, an audio cue can tell the user (via audio instructions) to, for example, “Say Ahh!,” subsequently captures one or more photos in response to hearing the user say “Ahh!” (via the microphone onboard the user device).

In some embodiments, haptic feedback can include vibration to indicate to the user that the camera is adequately positioned. For example, an intensity and/or frequency of haptic feedback may be adjusted based at least in part on the position and/or orientation of the user device relative to the user's mouth. In some embodiments, audio feedback may be adjusted in a similar manner.

In some embodiments, visual feedback can be provided on another device (e.g., a device that the user can still see). For example, the smartphone may stream live video as captured by its camera to another device, such as a smart watch that is worn by the user. In some embodiments, one or more sensors of the user device other than the camera described herein may alternatively or additionally be utilized in the performance of one or more of the operations described with reference to FIGS. 3 and 4. Examples of such sensors can include IMUs, gyroscopes, LiDAR devices, additional cameras, proximity sensors, and the like.

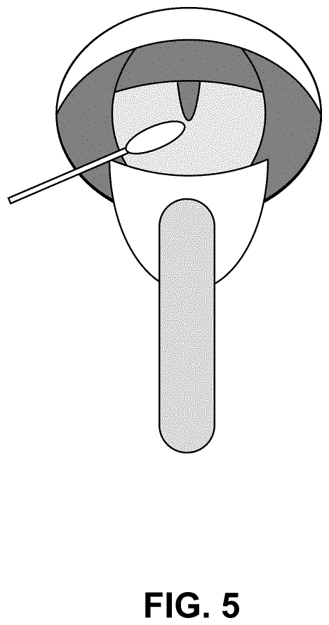

As shown in FIG. 5, collecting a throat sample can be challenging at least in part because the user may depress the tongue using a tongue depressor while inserting a swab to the appropriate location in the back of the throat. If a user wants to self-collect a sample or to have another person assist them in collecting a sample, an apparatus for holding the tongue depressor may be advantageous as it may enable the user or assistant to hold the phone and obtain AR guidance while also manipulating the tongue depressor and swab. In some embodiments, a tongue depressor attachment can clip onto a user's device, such as a phone or tablet. The tongue depressor attachment can include an area to receive and secure a separate tongue depressor, which may be disposable or reusable. The tongue depressor may, in some embodiments, be a standard medical item. In some embodiments, the tongue depressor may be customized for a particular sample collection process. For example, a customized tongue depressor may include markers, measures, colors, textures and so forth to assist in computer vision processes for guiding the user through the sample collection process.

In some embodiments, the tongue depressor may be wider than standard depressors, which may help to cover the tongue and thereby reduce the likelihood of sample contamination. Further, a wider depressor may reduce the complexity of applying computer vision techniques. In some embodiments, the tongue depressor may come in different sizes, while in other embodiments the depressor may come in a single size that the user can modify, for example by trimming or by tearing along pre-marked lines.

The tongue depressor attachment can include at least one mirror configured to receive light from a user's device (e.g., smartphone or tablet flashlight) and to redirect said light to the user's mouth/throat to aid in sample collection.

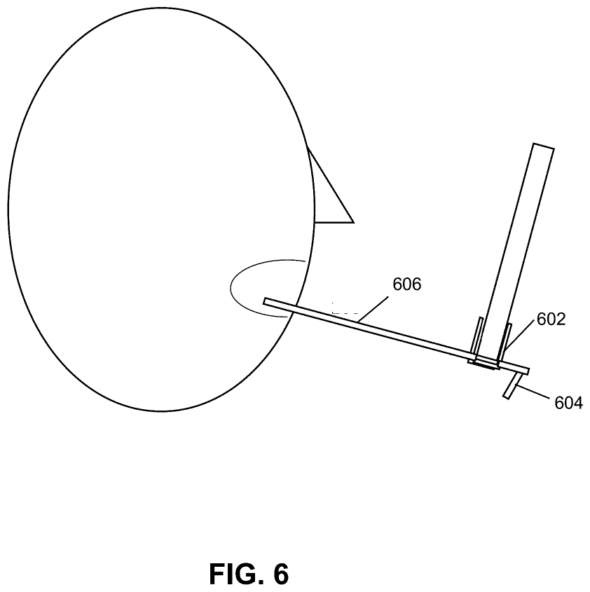

In some embodiments, a system may be configured to provide a sample collection process to a user. The sample collection process may be provided by a web page, native application, and so forth. In some embodiments, a user may collect their own sample, while in other embodiments, another person may collect the sample from the user. If the user is collecting their own sample, the system may turn on the front-facing camera and the flashlight of the user's device, and the tongue depressor attachment may be clipped onto the device in a first orientation. For example, FIG. 6 shows an example of self-collection in which a tongue depressor attachment 602 is attached to the user's phone. The tongue depressor attachment has a mirror 604 for directing light from the flashlight to the user's mouth. The tongue depressor attachment 602 is capable of holding a tongue depressor 606. Self-collection may present various difficulties. Thus, the system may instruct the user to hold the phone upside down so that the camera is at the bottom of the device, may flip the screen so that the screen behaves like a mirror, and so forth. The system may use computer vision (CV) data and/or device sensor data (e.g., device orientation data) to determine if the device is correctly positioned.

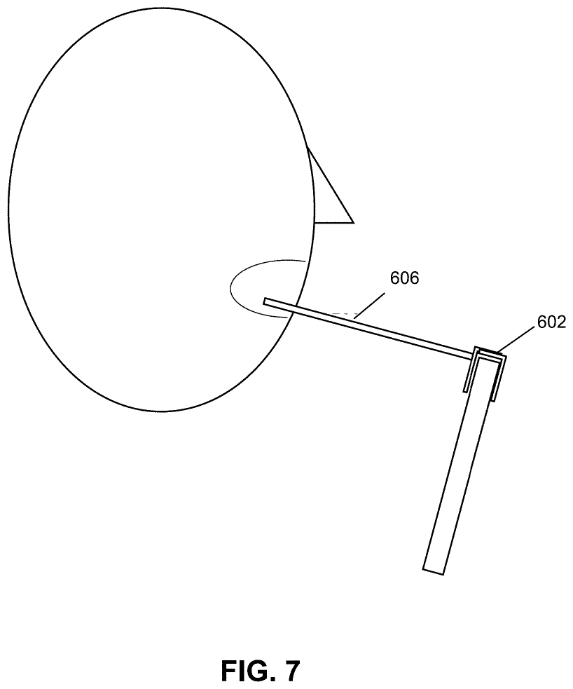

If another person is collecting the sample, the system may turn on the rear-facing camera and flashlight, in which case the light can shine directly into the user's mouth. In FIG. 7, the tongue depressor attachment 602 may be secured to the phone and the tongue depressor 606 may extend from the rear of the phone to the user. In this configuration, the mirror may be omitted, although in some embodiments a mirror may be included and may be used to aid in directing light into the mouth. In either sample collection case (e.g., self-collection or collection by another person), an augmented reality (AR) visualization may be rendered by the system on the screen of the user device. In some cases, instead of using the flashlight of the user device, the user device's screen may be used for illumination, for example by configuring the screen to display white at a high brightness.

The system may instruct the user to open their mouth. For example, the system may use computer vision to detect an amount of separation of the lips and may prompt the user to open their mouth to at least a minimum threshold separation. As described briefly above, facial feature tracking may work well when the user device is relatively far from the user but may struggle when the user device is close enough to the mouth for sample collection and other facial features are out of sight. Thus, in some embodiments, a two-phase approach may be used, in which facial tracking is used to instruct the user to open their mouth and to confirm that the mouth is open to at least a minimum threshold. In a second phase, a custom mouth computer vision (CV) for recognizing features of the mouth may be used. For example, in the second phase, the computer vision system may be capable of recognizing features such as the user's tonsils, uvula, and so forth. The mouth CV system should preferably be capable of operating reliably even in cases of considerable anatomical differences. For example, some users may have had tonsillectomies or other procedures. Similarly, users may have varying numbers of teeth and the arrangement of teeth may be inconsistent among different users.

In some embodiments, the system may instruct the user to perform one or more steps to prepare for collecting a sample. For example, the system may instruct the user to say “ahh” or to stick their tongue out. The system may recognize the user's tongue using the mouth CV and determine that the tongue is out of the way for sampling and for viewing the throat by the camera of the user's device. In some embodiments, the system may use audio to detect that the user said “ahh” to aid in confirming that the mouth is open, recognizing structures in the mouth, and confirming that the user's device camera can see the throat/target sample area.

In some embodiments, the system may check the visibility to the tonsils and/or the back of the throat. For example, the system may make sure that there is a clear path for a swab (e.g., tongue/lips are out of the way, throat/uvula/tonsils visible, etc.). The system may, in some embodiments, check to see if the user's device includes depth-sensing hardware either on the front of the device (if the user is collecting their own sample) or on the back of the device (if another person is aiding the user in collecting the sample). If the system detects the presence of depth-sensing hardware, the system may use the hardware to help with confirming that the path to the sample collection area (e.g., throat, tonsils, uvula) is clear. Depth information may also be used in other parts of the sample collection process, for example to aid in guiding the user to properly place the swab.

In some embodiments, if lighting is inadequate, the CV system may struggle to recognize features and objects and the system may alert the user that the lighting is inadequate and that the user should change positions or find additional lighting.

In some embodiments, the system may instruct the user to insert a tongue depressor, spoon, or the like to depress the tongue. In some embodiments, the system may confirm that the tongue depressor or another suitable object is being used (e.g., is visible) to depress the tongue. Alternatively, rather than confirming that the tongue depressor or other object is in place by detecting the object, the system may make a determination based on the visibility of the target (e.g., back of throat) area.

In some cases, users may struggle to depress their own tongue, and thus difficulty may be exacerbated by also trying to hold the phone. This can be the case for both self-collection and when another person is aiding the user. Thus, in some embodiments, the system may suggest hand postures that may be easier, or the system may instruct the user to use a tongue depressor attachment that clips onto the phone, as described above.

In some cases, the system may be configured prescreen for test eligibility and/or to help guide the user to swab the best sample region. For example, in some embodiments, CV algorithms may be used to detect symptoms of strep throat in the target area. For example, the sample area may be reddened, swollen, have white patches or pus, etc. The presence of one or more of these strep symptoms may be used in diagnosing the user's condition and/or in generating or ruling out differential diagnoses. Depending on the presence or lack of certain symptoms, the system may determine whether or not the user should proceed with taking a particular test. In some embodiments, the test kit may be part of a “first aid” kit, which may present the user with a brief symptom survey to determine if a condition (e.g., strep) is likely. The system may then use CV to look for symptoms and, if symptoms are detected, may recommend testing. In some embodiments, if a test is positive, the system may transition the user to a treatment phase.

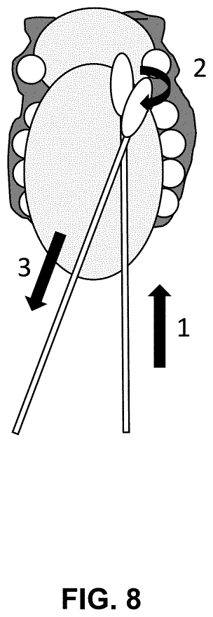

In some embodiments, the system may be configured to show the user (or the user's assistant) how to collect the sample. For example, the system may show the user/assistant which areas to touch and/or which areas to avoid. The system may provide guidance regarding how to properly swab given that users may move around, may gag, and so forth. For example, as shown in FIG. 8, the system may indicate how the user should insert the swab, collect the sample, and then remove the swab. In some embodiments, the system may provide an AR overlay of target regions (e.g., tonsils, back of throat, uvula, etc.) and/or an AR overlay of regions to avoid (for example, the tongue, sides/top of mouth, and so forth). In some embodiments, the system may provide a visualization to show the correct trajectory/motion of the swab before the user/assistant actually performs the swabbing process. In some embodiments, the system may provide an animation that shows the swift swabbing motion in order to illustrate which areas to swab and the speed with which the swabbing should be performed. For example, if a user or assistant swabs too slowly, this may increase the time needed to collect a sample and may increase the likelihood or severity of gagging.

In some cases, touching the swab to non-target areas such as the tongue, cheeks, roof of the mouth, and so forth may result in an invalid test. Thus, in some embodiments, CV algorithms may be used to detect if the swab has touched areas outside the target area(s) and may inform the user if such contact is detected. In some embodiments, the throat sample collection may be part of a remotely proctored test, and the proctor may observe the swabbing process to verify that the swab did not touch non-target areas.

In some cases, CV algorithms may be optimized for swab detection and throat sample collection. For example, the system may use computer vision to detect if the swabbing action was sufficient, although in some cases insufficient lighting and/or slow camera response may make it difficult or infeasible to determine swipe speed accurately. In some cases, CV may be used to measure swab tip depth. Swab tip depth may be measured by using depth sensing camera hardware, by relying on anatomical markers such as teeth, the uvula, and so forth, and/or using CV-readable markers placed on the tongue depressor. Measuring the swab tip depth may help to ensure that the swab reached far enough to contact the sample area. In some embodiments, a proctor may evaluate the swab tip depth to determine if the swab was inserted far enough to collect a valid sample.

### Examples for Saliva Sample Collection

As mentioned briefly above and as will now be explained in more detail, this application describes systems, methods, and devices for increasing saliva production in testing users undergoing proctored at-home testing or sample collection.

In general, during at-home testing or sample collection with third party verification, the testing user may respond to a questionnaire at the beginning of the process. This questionnaire may gather, among other things, information about the testing user and their symptoms. In some cases, the questionnaire may include questions that relate to food, such as whether the testing user is experiencing any gastrointestinal issues or suffers from any allergies.

In some embodiments, the questionnaire may present the testing user with questions that are designed to gather information that can be useful in stimulating salivation. For example, in some embodiments, a testing user may be asked to provide their favorite food. In some embodiments, saliva production may be facilitated by presenting the testing user with images of food and asking the testing user to select the most appetizing food item. In some embodiments, saliva production may be stimulated by asking the testing user to select a desired food from a list of foods.

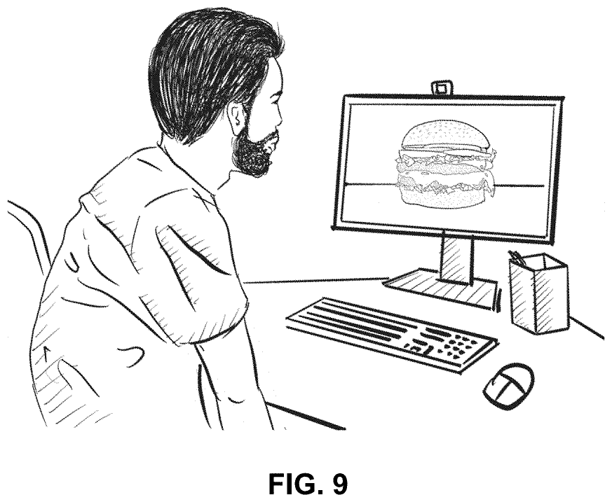

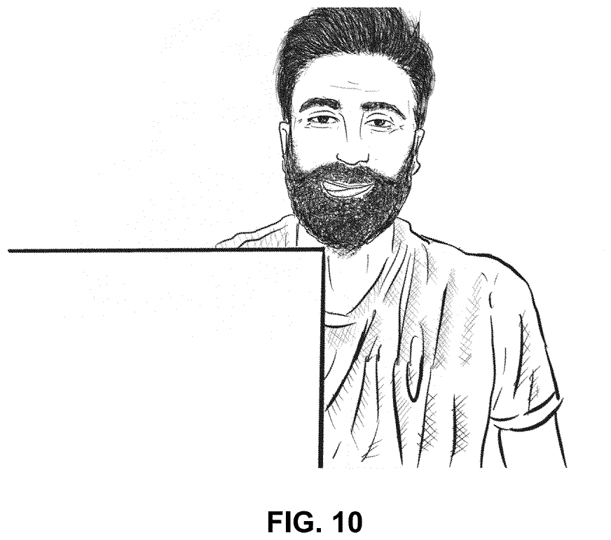

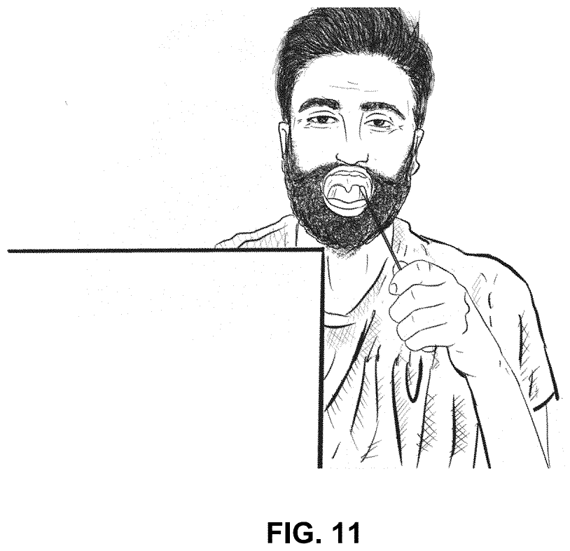

In some embodiments, the testing user's responses to questions about food preferences may be used later in the testing process, when saliva needs to be collected. In some embodiments, the testing user may be shown an image of a desirable food item just prior to or during saliva sample collection. In some embodiments, the testing user may be shown an augmented reality representation of the food item, while in some embodiments, the testing user may be shown a video of the food item. In some embodiments, the testing user may be shown a regular image of the food. In some embodiments, the food is presented to the user just prior to sample collection. In some embodiments, the food is shown to the user during sample collection. In some embodiments, the user is also given instructions with respect to the food, such as to imagine eating it or to imagine the smell or taste of the food item. As an illustration, in FIG. 9, the testing user is presented with an image of a hamburger prior to sample collection. FIG. 10 then illustrates that the image has caused the testing user to salivate. FIG. 11 then depicts the testing user, after experiencing the stimulus, collecting a saliva sample using a swab.

In some embodiments, the displayed image, video, or augmented reality representation of the food item is dynamically selected based on the testing user's provided information along with past performance data that indicates which images, videos, or augmented reality representations result in the highest amount of saliva production. Past performance may be determined, for example, by analyzing aggregate data from prior testing users that indicates which images or representations were most likely to result in collection of a usable saliva sample.

In some embodiments, the testing user may be offered the opportunity to purchase the food item that is displayed to them, such as, for example, providing the testing user with a link to place an order through a delivery service. In some embodiments, a testing platform can partner with one or more food related establishments, such as restaurants, and play advertisements for the restaurants to stimulate salivation. This can provide beneficial advertising for the food establishment, generating revenue, while simultaneously facilitating saliva collection.

In some embodiments, the testing user's food preferences may not be available. In some embodiment, the testing user may be shown a video of people eating a sour food, which may increase salivation. In some embodiments, the testing user may, for example, be shown a lemon on the table in front of them using augmented reality and instructed to imagine eating it. In some embodiments, the testing user may be presented with images or other representations of food that have, based on past performance data, been identified as more likely to result in successful sample production.

### Computer Systems

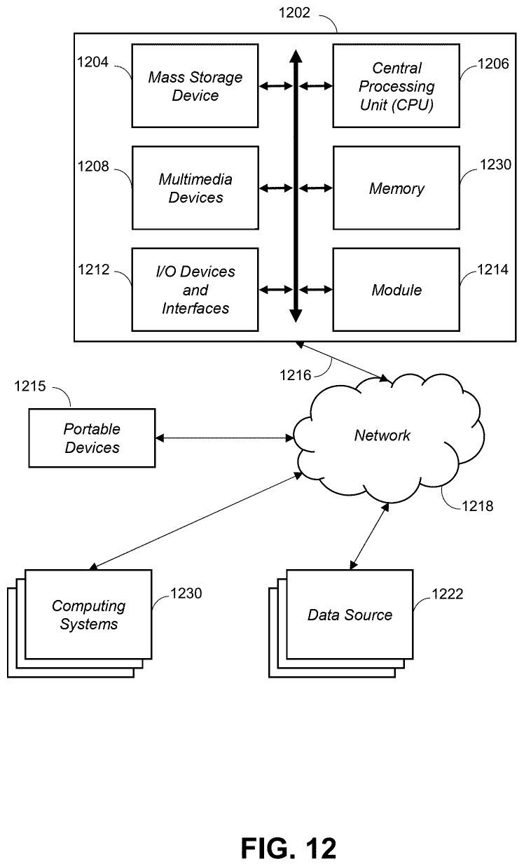

FIG. 12 is a block diagram depicting an embodiment of a computer hardware system configured to run software for implementing one or more embodiments of the health testing and diagnostic systems, methods, and devices disclosed herein.

In some embodiments, the systems, processes, and methods described herein are implemented using a computing system, such as the one illustrated in FIG. 12. The example computer system 1202 is in communication with one or more computing systems 1220 and/or one or more data sources 1222 via one or more networks 1218. While FIG. 12 illustrates an embodiment of a computer system 1202, it is recognized that the functionality provided for in the components and modules of computer system 1202 may be combined into fewer components and modules, or further separated into additional components and modules.

The computer system 1202 can comprise a module 1214 that carries out the functions, methods, acts, and/or processes described herein (e.g., processes as discussed above). The module 1214 is executed on the computer system 1202 by a central processing unit (CPU) 1206 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 1202 includes one or more CPUs 1206, which may comprise a microprocessor. The computer system 1202 further includes a physical memory 1210, such as random-access memory (RAM) for temporary storage of information, a read only memory (ROM) for permanent storage of information, and a mass storage device 1204, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1202 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1202 includes one or more input/output (I/O) devices and interfaces 1212, such as a keyboard, mouse, touch pad, and printer. The I/O devices and interfaces 1212 can include one or more display devices, such as a monitor, that allows the visual presentation of data to a user. More particularly, a display device provides for the presentation of GUIs as application software data, and multi-media presentations, for example. The I/O devices and interfaces 1212 can also provide a communications interface to various external devices. The computer system 1202 may comprise one or more multi-media devices 1208, such as speakers, video cards, graphics accelerators, and microphones, for example.

The computer system 1202 may run on a variety of computing devices, such as a server, a Windows server, a Structure Query Language server, a Unix Server, a personal computer, a laptop computer, and so forth. In other embodiments, the computer system 1202 may run on a cluster computer system, a mainframe computer system and/or other computing system suitable for controlling and/or communicating with large databases, performing high volume transaction processing, and generating reports from large databases. The computer system 1202 is generally controlled and coordinated by an operating system software, such as z/OS, Windows, Linux, UNIX, BSD, SunOS, Solaris, macOS, iOS, iPadOS, Android, or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 1202 illustrated in FIG. 12 is coupled to a network 1218, such as a LAN, WAN, or the Internet via a communication link 1216 (wired, wireless, or a combination thereof). Network 1218 communicates with various computing devices and/or other electronic devices. Network 1218 is communicating with one or more computing systems 1220 and one or more data sources 1222. The module 1214 may access or may be accessed by computing systems 1220 and/or data sources 1222 through a web-enabled user access point. Connections may be a direct physical connection, a virtual connection, and other connection type. The web-enabled user access point may comprise a browser module that uses text, graphics, audio, video, and other media to present data and to allow interaction with data via the network 1218.

Access to the module 1214 of the computer system 1202 by computing systems 320 and/or by data sources 322 may be through a web-enabled user access point such as the computing systems' 1220 or data source's 1222 personal computer, cellular phone, smartphone, laptop, tablet computer, e-reader device, audio player, or another device capable of connecting to the network 1218. Such a device may have a browser module that is implemented as a module that uses text, graphics, audio, video, and other media to present data and to allow interaction with data via the network 1218.

The output module may be implemented as a combination of an all-points addressable display such as a cathode ray tube (CRT), a liquid crystal display (LCD), a plasma display, or other types and/or combinations of displays. The output module may be implemented to communicate with input devices and interfaces 1212 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the computer system 1202 may comprise a physical or logical connection established between a remote microprocessor and a mainframe host computer for the express purpose of uploading, downloading, or viewing interactive data and databases on-line in real time. The remote microprocessor may be operated by an entity operating the computer system 1202, including the client server systems or the main server system, an/or may be operated by one or more of the data sources 1222 and/or one or more of the computing systems 1220. In some embodiments, terminal emulation software may be used on the microprocessor for participating in the micro-mainframe link.

In some embodiments, computing systems 1220 who are internal to an entity operating the computer system 1202 may access the module 1214 internally as an application or process run by the CPU 1206.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computer system 1202 may include one or more internal and/or external data sources (for example, data sources 1222). In some embodiments, one or more of the data repositories and the data sources described above may be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 1202 may also access one or more data sources 1222. The data sources 1222 may be stored in a database or data repository. The computer system 1202 may access the one or more data sources 1222 through a network 1218 or may directly access the database or data repository through I/O devices and interfaces 1212. The data repository storing the one or more data sources 1222 may reside within the computer system 1202.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein, but are to be accorded the widest scope consistent with this disclosure, the principles and the novel features disclosed herein.

What is claimed is:

1. A computer-implemented method for assisting a user in self-imaging a user's mouth or throat using a camera on a user device, the method comprising:
receiving, by a computer system, a first set of images captured by the user using the camera of the user device, the first set of images include a view of a mouth of the user;
determining, by the computer system and based on the first set of images, an extent to which the mouth of the user is open;
determining, by the computer system and based on the first set of images, a distance between the camera and the mouth of the user;
based on the extent to which the user's mouth is open and the distance between the camera and the user's mouth, determining, by the computer system, that one or more image criteria is met, the image criteria configured to ensure that the mouth and throat of the user are visible within a field of view of the camera; and
based on determining that the image criteria are met, causing, by the computer system, the user device to capture a second set of images of the user's mouth using the camera on the user device.

2. The method of claim 1, wherein determining, based on the first set of images, an extent to which the user's mouth is open comprises:
identifying, by the computer system, keypoints within the first set of images associated with an upper lip and a lower lip of the user; and
determining, by the computer system, a distance between the keypoints.

3. The method of claim 1, further comprising, based on determining that the image criteria are not met:
providing, by the computer system, instructions to the user to reposition the camera; and
receiving, by the computer system, an updated first set of images from the camera of the user device.

4. The method of claim 3, wherein the instructions comprise audio instructions played on a speaker of the user device.

5. The method of claim 1, further comprising sending, by the computer system, the second set of images over a network to a telehealth platform for analysis or review.

6. The method of claim 1, wherein the image criteria include a degree to which the mouth of the user is open exceeding a threshold degree.

7. The method of claim 1, wherein the image criteria include a distance between the mouth of the user being within a threshold distance.

8. The method of claim 1, wherein the image criteria include a determination that a feature of interest is positioned within a center region of the field of view of the camera.

9. The method of claim 8, wherein the feature of interest comprises the throat of the user.

10. The method of claim 1, further comprising, causing, by the computer system, a flash of the user device to trigger prior to capturing the second set of images.

11. The method of claim 1, wherein one or both of the first set of images or the second set of images comprises a single image.

12. A computer system for assisting a user in self-imaging a user's mouth or throat using a camera on a user device, the system comprising at least one memory and at least one processor, the at least one memory storing instructions that cause the processor to:
receive a first set of images captured by the user using the camera of the user device, the first set of images include a view of a mouth of the user;
determine, based on the first set of images, an extent to which the mouth of the user is open;
determine, based on the first set of images, a distance between the camera and the mouth of the user;
based on the extent to which the user's mouth is open and the distance between the camera and the user's mouth, determine that one or more image criteria is met, the image criteria configured to ensure that the mouth and throat of the user are visible within a field of view of the camera; and
based on determining that the image criteria are met, cause the user device to capture a second set of images of the user's mouth using the camera on the user device.

13. The system of claim 12, wherein determining, based on the first set of images, an extent to which the user's mouth is open comprises:
identifying keypoints within the first set of images associated with an upper lip and a lower lip of the user; and
determining a distance between the keypoints.

14. The system of claim 12, wherein the processor is further configured to, based on determining that the image criteria are not met:
provide instructions to the user to reposition the camera; and
receive an updated first set of images from the camera of the user device.

15. The system of claim 14, wherein the instructions comprise audio instructions played on a speaker of the user device.

16. The system of claim 12, further comprising sending, by the computer system, the second set of images over a network to a telehealth platform for analysis or review.

17. The system of claim 12, wherein the image criteria include a degree to which the mouth of the user is open exceeding a threshold degree.

18. The system of claim 12, wherein the image criteria include a distance between the mouth of the user being within a threshold distance.

19. The system of claim 12, wherein the image criteria include a determination that a feature of interest is positioned within a center region of the field of view of the camera.

20. The system of claim 19, wherein the feature of interest comprises the throat of the user.
